(19) United States
(12) Patent Application Publication
(10) Pub. No.: US 2014/0007229 A1
(43) Pub. Date: Jan. 2, 2014

(54) SYSTEM AND METHOD FOR IDENTIFYING INSTALLED SOFTWARE PRODUCTS

(71) Applicants: CHRISTOPHER T. SMITH, Sherwood, OR (US); David M. Bleckmann, Portland, OR (US)

(72) Inventors: CHRISTOPHER T. SMITH, Sherwood, OR (US); David M. Bleckmann, Portland, OR (US)

(21) Appl. No.: 13/537,901

(22) Filed: Jun. 29, 2012

(51) Int. Cl. G06F 21/00

(52) U.S. Cl. 726/22

(57) ABSTRACT

One embodiment includes a software identification system. The system includes an enterprise trust server configured to initiate a scan of at least one file of a file system of a computer system to generate a respective at least one file signature. The at least one file signature includes cryptographic hash data associated with file content of the at least one file. The system also includes a trust repository configured to receive the at least one file signature and to compare the at least one file signature, including the cryptographic hash data associated with the file content thereof, with predetermined file signature data that is stored in a software product reference storage. The predetermined file signature data can include cryptographic hash values associated with respective files in predetermined corresponding software products to enable identification of at least one software product with which the at least one given file is associated.

### TECHNICAL FIELD

This disclosure relates generally to a system and method for identifying installed software products.

### BACKGROUND

File systems on computers and computer systems can store a variety of different software files. The software files that are stored in the file systems can correspond to a number of different software products that are installed on the given computer or computer system. It is often necessary to access and identify the software files stored in the file systems, such as for maintenance and troubleshooting purposes. One such example can be to determine if a malicious computer virus or malware has been loaded onto the computer system. Many of the software files that are stored in a computer system are generated and/or utilized by the computer system in a manner that is transparent to the user, such as by the result of the operation of background processes of software products that run on the respective computer system. Such software files can often still be accessed from the file system by a user.

### SUMMARY

One embodiment includes a software identification system. The system includes an enterprise trust server configured to initiate a scan of at least one file of a file system of a computer system to generate a respective at least one file signature. The at least one file signature includes cryptographic hash data associated with file content of the at least one file. The system also includes a trust repository configured to receive the at least one file signature and to compare the at least one file signature, including the cryptographic hash data associated with the file content thereof, with predetermined file signature data that is stored in a software product reference storage. The predetermined file signature data can include cryptographic hash values associated with respective files in predetermined corresponding software products to enable identification of at least one software product with which the at least one given file is associated.

Another embodiment includes a non-transitory computer-readable medium programmed for performing a method for identifying software on a computer system. The method includes generating at least one file signature corresponding to a respective at least one file stored in a computer system. The at least one file signature can include cryptographic hash data encoding file content of the at least one file. The method also includes sending the at least one file signature to a trust repository as part of a software-identification request. The method also includes receiving a response corresponding to results from a comparison of the cryptographic hash data with predetermined cryptographic hash data that is associated with predetermined software products at the trust repository. The method further includes generating a software-identification report associated with identification of at least one software product with which the at least one file is associated based on the comparison of the cryptographic hash data with the predetermined cryptographic hash data.

Another embodiment includes a network system. The system includes a plurality of enterprise trust servers that are each configured to initiate a scan of a plurality of files from at least one file system associated with at least one computer system and to generate a plurality of file signatures corresponding to the respective plurality of files. Each of the plurality of file signatures includes cryptographic hash data associated with file content of the respective one of the plurality of files. The system also includes a trust repository communicatively coupled to the plurality of enterprise trust servers via a network and configured to receive a product identification request that includes the plurality of file signatures from each of the plurality of enterprise trust servers. The trust repository can also compare the plurality of file signatures including the cryptographic hash data associated with the file content with predetermined file signatures stored in a software product reference storage. The predetermined file signatures stored in the software product reference storage can be associated with predetermined known software products to enable identification of at least one software product with which each of the plurality of files is associated.

### BRIEF DESCRIPTION OF THE DRAWINGS

FIG. 1 illustrates an example of a software identification system in accordance with an aspect of the invention.

FIG. 2 illustrates an example of a file signature in accordance with an aspect of the invention.

FIG. 3 illustrates an example of a software identification report in accordance with an aspect of the invention.

FIG. 4 illustrates an example of a network system in accordance with an aspect of the invention.

FIG. 5 illustrates an example of a method for identifying software on a computer system in accordance with an aspect of the invention.

### DETAILED DESCRIPTION

This disclosure relates to a system and method for identifying installed software products. The system can include an enterprise trust server (ETS) that is coupled to one or more computer systems, such as via a network. The ETS can initiate a scan of one or more files, such as may be stored in a file system associated with the computer system. The scan can be performed via an ETS client, such as a software module that is installed on the computer system. The scan, for example, can be initiated in response to a software-identification request, such as initiated at the ETS. The ETS client can then generate at least one file signature corresponding to the at least one file. The file signature can include characteristics associated with the at least one file, such as file name, path, attributes, permissions, and content. As an example, the ETS can be programmed to generate the file signature to include cryptographic hash data corresponding to the file content.

The ETS can be programmed to transmit the file signature(s) to a trust repository via a network, such as the Internet, an intranet, or a combination thereof. The trust repository can be programmed to implement a matching algorithm to compare the file signature with predetermined software file signature data. The trust repository can thus identify at least one software product with which the respective file(s) are associated based on the results of the comparison. The comparison could yield results that indicate probabilities of more than one software product with which the at least one file is associated, such as based on the matching algorithm results. The results can be returned to the ETS. The ETS can be programmed to generate a user-viewable report based on the results, such as including scores or other indications of a likelihood that the file(s) belong to different possible products.

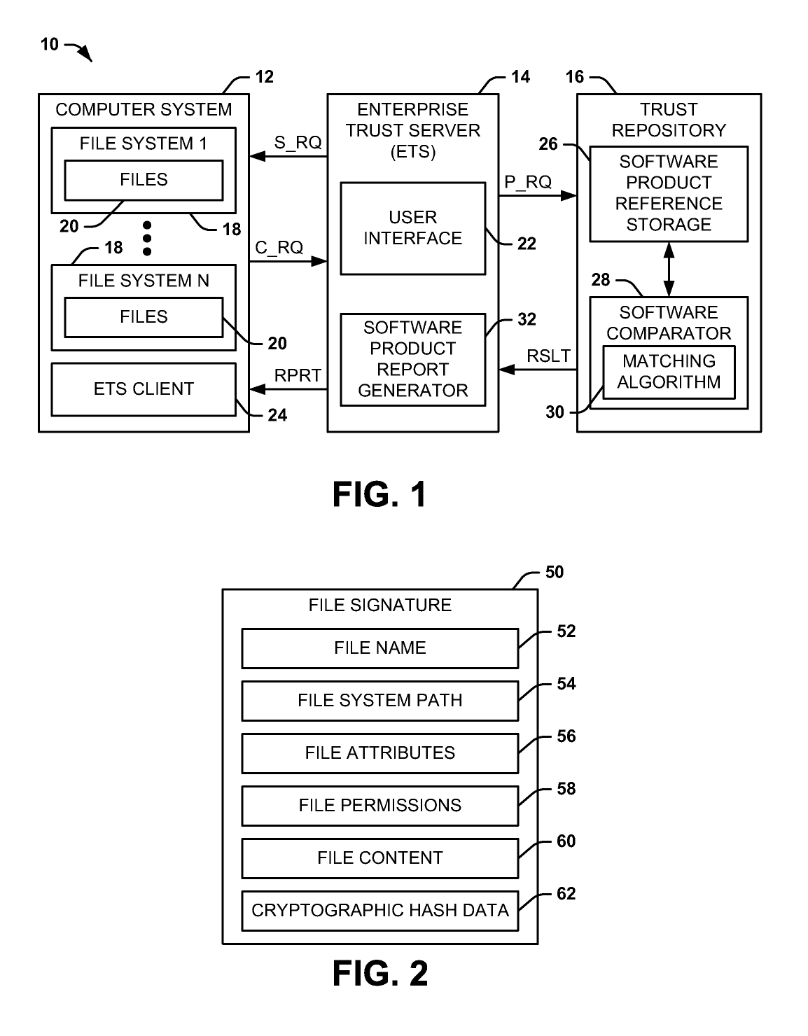

FIG. 1 illustrates an example of a software identification system 10. As an example, the software identification system 10 can be distributed in a network system, such as a local-area network (LAN) and/or a wide-area network (WAN), or could be configured in a virtual network on a single computer system. In the example of FIG. 1, the software identification system 10 includes a computer system 12, an enterprise trust server (ETS) 14, and a trust repository 16. As an example, the computer system 12 can be configured as a single computer, such as a personal computer, work station, or an enterprise server, or could be implemented to include a plurality of computers, such as configured in a network.

In the example of FIG. 1, the computer system 12 includes a plurality N of file systems 18, where N is a positive integer, that each respectively include one or more files 20. As described herein, the term “file system” is intended to refer to any of a variety of computer storage systems containing one or more files. For example, the file systems 18 in the example of FIG. 1 can include hard disks, solid-state drives and devices, flash devices, floppy disks, CD/DVD media, a variety of read only memory (ROM) chips and/or embedded systems, such as can be configured to store basic input/output system (BIOS)/Operating System data, and/or any of a variety of other types of similar storage media. As another example, the file systems 18 can include peripheral storage devices, as well as storage devices configured internally with respect to the computer system 12. As described herein, the term “file” is intended to refer to a sequence of binary data or bytes that can be stored in the file systems 18, such that the files 20 can have an associated name and path that identifies where it is stored in the respective file system 18. Each file can also include metadata that describes the data stored therein.

The ETS 14 is communicatively coupled to the computer system 12, such as via a network (e.g., a LAN, a WAN, and/or the Internet). The ETS 14 can be configured to communicate with the computer system 12 to act as a liaison between the computer system 12 and the trust repository 16 for identification of software products associated with the files 20 stored in the file systems 18, as described in greater detail herein. In the example of FIG. 1, the ETS 14 includes a user interface 22. As an example, the user interface 22 can be accessible by a user at the ETS 14 and/or can be accessible by a user at the computer system 12 via the associated network, such that the user interface 22 can correspond to a webpage or mobile device application. The ETS 14 can initiate a software-identification request, demonstrated as S_RQ, which is provided to the computer system 12. As an example, the software-identification request S_RQ can be provided by a user input via the user interface 22, or can be performed periodically and/or automatically by a program executing on a processor of the computer system 12 or the ETS 14. For example, the software-identification request S_RQ can be provided in response to downloading and/or uploading data to and/or from the computer system 12. While the request S_RQ is demonstrated as originating from the ETS 14, the request to the computer system 12 can be provided from a different system or process that is different from or outside of the ETS 14, such as the computer system 12 or a different system altogether. As disclosed herein, such request may be automatically generated or be responsive to a user input.

The software-identification request S_RQ can delineate one or more of the files 20 that are stored in one or more of the file systems 18 and/or file containers (e.g., one or more file systems 18) for which identification of corresponding software products is requested. The delineation of the files 20 for which identification is requested can be based on any combination of groupings of the files 20 in the file system(s) 18, and may not require any sort of cohesiveness associated with the files 20. For example, the files 20 for which identification is requested can be selected arbitrarily by a user, by the ETS 14, or by the computer system 12, and need not be stored in the same file system 18 or associated with a given one process (e.g., a given sub-directory or query result). Accordingly, any one or more files 20 can be selected from any one or more of the file systems 18 for identification in the software-identification request S_RQ.

In the example of FIG. 1, the computer system 12 includes an ETS client 24 that can be responsive to the software-identification request S_RQ to perform a scan of the requested files 20 from the respective file systems 18. The scan of the files 20 or the associated file system(s) 18 can be operative to generate metadata for each of such files 20 delineated in the request S_RQ. The ETS client 24 can thus generate a file signature for each of files 20 that are delineated in the software-identification request S_RQ as a result of the scan. While it is demonstrated in the example of FIG. 1 that the ETS client 24 is resident on the computer system 12, it is to be understood that the ETS client 24 could instead reside elsewhere, such as on a remote device that is coupled to the network or on the ETS 14.

FIG. 2 illustrates an example of a file signature 50 that can be generated by the ETS client 24 of FIG. 1. The file signature 50 can be constructed to characterize the file or files specified in the request S_RQ. In the example of FIG. 2, the file signature 50 can include a file name 52, a file system path 54, file attributes 56, file permissions 58, file content 60, and cryptographic hash data 62. For example, the file name 52 can include the text string that identifies the file 20 to a user, and can include a file extension. The file system path 54 can correspond to a logical location where the file 20 is stored in the corresponding file system 18, such as including directory and sub-directory information. The file attributes 56 can correspond to properties associated with the file 20, such as file size, modification times, and other general information regarding the file 20. File permissions 58 can correspond to security information associated with the file 20, such as including status as being read-only or being non-editable. The file content 60 can include at least a portion of the binary data of the file 20. The cryptographic hash data 62 can correspond to the cryptographic hash of at least a portion of the binary data of the file 20 represented as a cryptographic hash code.

As an example, the ETS client 24 can include or be programmed to employ a cryptographic hash function that is configured to generate the cryptographic hash data 62 based on at least a portion the binary data of file 20. For instance the cryptographic hash function can encode an arbitrarily sized portion of the binary data of the file 20 into a fixed-size bit string, namely a cryptographic hash value corresponding to the cryptographic hash data for such file 20. For example, the ETS client 24 can be configured to implement any of a variety of non-reversible data encoding algorithms to generate the cryptographic hash data 62 in a manner that substantially uniquely identifies each respect file 20 that is specified in the request S_RQ. As used herein, the term “substantially” is intended to indicate that while the function or results of the term being modified are a desired result that some variation can result. In this context, for example, the term “substantially uniquely” demonstrates that the resulting signatures usually are unique although it is statistically possible that the cryptographic hash for two files with different binary data could be the same. Some examples of cryptographic hash functions that can be utilized include MD5, SHA-1, and SHA-256 to name a few. The cryptographic hash data 62 of the given file 20 can thus include encoded information (e.g., a cryptographic hash value) that can be indicative of one or more software products with which the given file 20 is associated.

It is to be understood that the file signature 50 is not intended to be limited to the example of FIG. 2. For example, while the file signature 50 includes the file name 52, the file system path 54, the file attributes 56, the file permissions 58, the file content 60, and the cryptographic hash data 62, it is to be understood that the file signature 50 can include less information, additional information, or other forms of information associated with the respective file 20 that is not demonstrated in the example of FIG. 2. Therefore, the file signature 50 can be configured in a variety of different ways.

Referring back to the example of FIG. 1, upon generating file signatures for each of the files 20 delineated in the software-identification request S_RQ via the ETS client 24, the ETS client 24 can provide the file signatures to the ETS 14 as a client request C_RQ. As an example, the client request C_RQ can be constructed as a well-formed request (e.g., an XML document). The ETS 14 can be configured to store the client request C_RQ and to package the client request C_RQ as a product identification (ID) request P_RQ that is provided to the trust repository 16. For example, the product ID request P_RQ can include data that specifies a hash algorithm utilized to generate the respective file signatures, settings and parameters that are to be included in a response, and each file signature that is part of the request. For instance, the settings to be returned in the associated response can specify whether the results are to include matches, deviations, passed tests, failed tests, errors and related values. The instructions to the trust repository 16 can also specify resources that are to perform the identification process. It is to be understood that, while the example of FIG. 1 demonstrates that the ETS 14 provides the product ID request P_RQ in response to the client request C_RQ, it is to be understood that the computer system 12 could instead provide the client request C_RQ directly to the trust repository 16, such that the client request C_RQ can correspond to the product ID request P_RQ.

For example, the trust repository 16 can be coupled to the ETS 14 via a network, such as a WAN and/or LAN. As another example, the trust repository 16 could reside on the same computer system as the ETS 14, and communication between the ETS 14 and the trust repository 16 could take place over inter-process communications. For instance, the trust repository 16 can correspond to a Global Trust Repository (GTR) that is coupled to the Internet, and thus accessible from a plurality of enterprise trust servers, including the ETS 14, via the Internet. The trust repository 16 includes a software product reference storage 26 that is configured, for example, as a database to store predetermined file signature data corresponding to predetermined software products. For example, the software product reference storage 26 can include the characteristics associated file signatures of the predetermined software products, as well as predetermined cryptographic hash data associated with the file signatures, such that the file signatures that are provided to the trust repository 16 can be compared with the predetermined file signature data for identification of the software products with which the files 20 are associated.

As described herein, the term “software product” can refer to a specific commercial application software or software bundle. A software product can also refer to operating system software, to customized version of commercially available application software, or to completely custom software applications. Furthermore, a software product could also refer to a software upgrade or patch meant to be applied to one of the proceeding examples and may represent only a subset of files that comprise a complete working product. A given software product can include details regarding the manufacturer, the specific commercial software product name, as well as the specific version and/or release date. As one example, the software product reference storage 26 can store, among many other software products, reference data for each separate releases (e.g., versions) of every product associated with Microsoft® Office (e.g., including every release of Word, Access, Excel, Outlook, etc.).

Therefore, as an example, a single file signature may be associated several different products stored in the software product reference storage 26. For instance, two different releases of a given commercial software product, which can be stored separately in the software product reference storage 26, can contain certain files that are common to multiple separate releases. In such a case, the trust repository 16 can be configured to identify all of the version/releases associated with the given software product; however, the trust repository can be programmed to remove duplicates from the software product reference storage 26 to conserve storage space.

As a further example, the trust repository 16 being configured as the GTR can be populated with billions of file signatures that can be associated with millions software products. The trust repository 16 can include automated and manual harvesting methods that monitor websites and software download portals for major commercial software vendors and download new software products when they are released. The downloaded software products can be deconstructed and all contained files can be parsed to generate corresponding file signatures. Each file signature can include cryptographic hash values representing the file content, which is known. The created predetermined file signatures can be packaged together with information on the specific software product with which they are associated and can be stored as the predetermined file signature data, including the predetermined cryptographic hash data, in the software product reference storage 26. Additionally, the trust repository 16 can be configured to, in response to being unable to identify a given software product based on a file signature (e.g., the cryptographic hash data) provided in the product ID request P_RQ, the trust repository 16 can be configured to store the file signature in the software product reference storage 26, such as for future identification based on subsequent website harvesting or for matching with other similar file signatures for determining file associations.

In the example of FIG. 1, the trust repository 16 also includes a software comparator 28 that is programmed to receive the product ID request P_RQ and to implement a matching algorithm 30 for identification of the software product(s) that are associated with the respective files 20 based on the product ID request P_RQ. As an example, the matching algorithm 30 can be configured to compare elements of the cryptographic hash data with elements of the predetermined cryptographic hash data of the predetermined file signature data stored in the software product reference storage 26 to determine a matching score of a given file signature relative to a given set of software products. For example, the matching score can be based on a score of elements of the cryptographic hash data of one or more file signatures that are differently weighted for matches and non-matches of associated elements in the predetermined cryptographic hash data of the software products stored in the software product reference storage 26. The matching algorithm 30 can thus generate a set of matching scores for the one or more given file signatures that each represent a separate likelihood that given software products correspond to the software products with which the respective file(s) 20 are associated. The software comparator 28 can implement a threshold, such as to ignore matching scores that fall below a given threshold. Therefore, the software comparator 28 can discard matching scores that represent very unlikely possibilities of the file(s) 20 being associated with a respective software product. Thus, the software comparator 28 can be configured to narrow the evaluation to only relevant results.

Upon determining the results of the matching algorithm 30, the trust repository 16 can transmit the results to the ETS 14, demonstrated in the example of FIG. 1 as a response RSLT. The response RSLT can correspond to a report (e.g., an XML file) that includes data identifying all of the potential software products, including associated matching scores, which are associated with each of the files or each set of files delineated in the software-identification request S_RQ. For example, the results responsive to a given product ID request P_RQ, the trust repository can generate the results as a response that specifies each file that was included in the software-identification request S_RQ (e.g., by file name), an install path for each file, a time stamp for the file, as well as its score value, and a product identifier for the corresponding software product. The product identifier can be associated with additional details in the returned results, such as can include product-related parameters. The product-related parameters, for example, can include a product identifier (ID), a global unique identifier (GUID), product name, product vendor, a description or other metadata about the product, platform on which the product runs, vendor of the intended platform and/or other product attributes.

The ETS 14 can also include a software product report generator 32 that is configured to generate a user-viewable software-identification report that is indicative of the results, demonstrated as RPRT. The ETS 14 can be programmed to transmit the software-identification report RPRT to the user of the computer system 12. For example, the software-identification report RPRT can be generated in a format that is able to be accessed and viewed by the user of the computer system 12, such as in a portable document format (PDF) format. As another example, the software-identification report RPRT can be saved at the ETS 14, such that the user can view the report via the user interface 22, such as accessible as a webpage on the network.

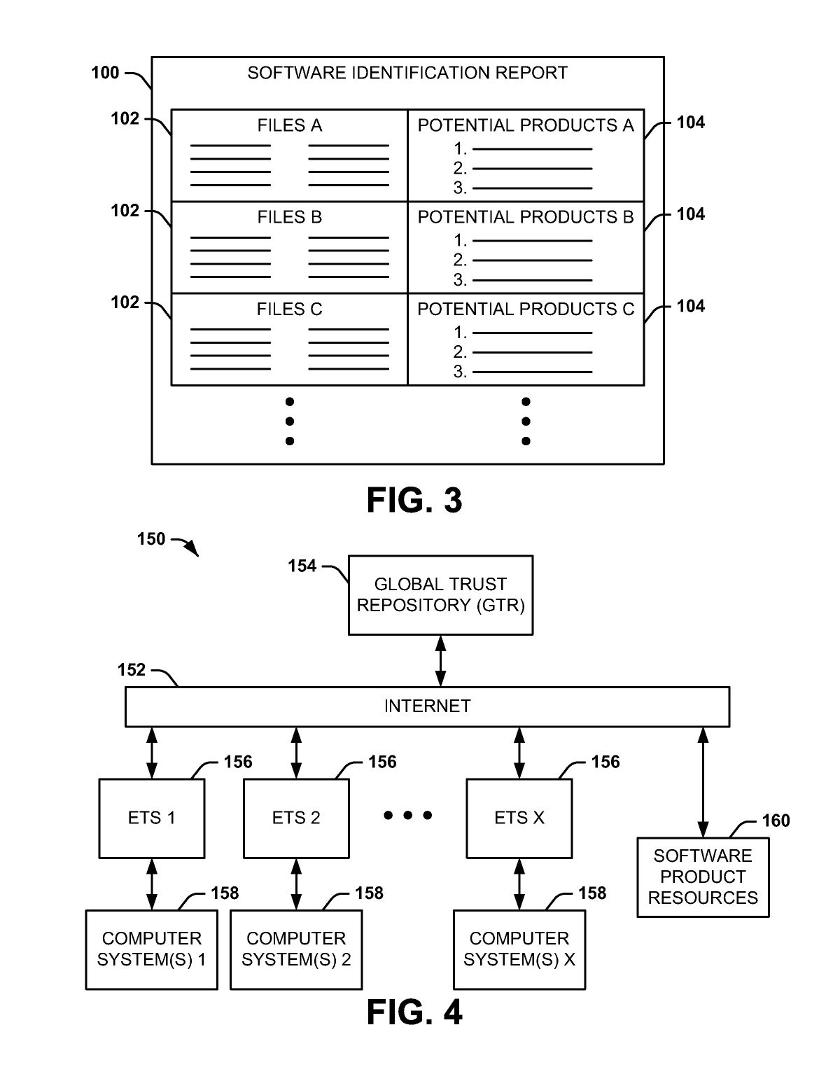

By way of additional context, FIG. 3 illustrates an example of a software-identification report 100 that can be generated (e.g., by the software product report generator 32 of the ETS 14). The software-identification report 100 can be provided in any of a variety of software file formats that can be accessed and/or viewed via the computer system 12. The software-identification report 100 includes a plurality of lists of files 102, demonstrated in the example of FIG. 3 as FILES A, FILES B, FILES C, etc., that can each include the files 20 that were delineated in the software-identification request S_RQ. The lists of files 102 can be organized by the trust repository 16 or the ETS 14 based on a likelihood of association with a given set of software products, such that each file in a given list of files 102 can all be associated with the same software product or products.

The software-identification report 100 also can include multiple sets of potential software products 104, demonstrated in the example of FIG. 3 as POTENTIAL PRODUCTS A, POTENTIAL PRODUCTS B, POTENTIAL PRODUCTS C, etc. that can be associated with each of the respective lists of files 102. Each of the sets of potential products 104 can thus demonstrate a list of one or more of the software products with which the files 20 in a given one of the lists of files 102 are likely to be associated. The potential products 104 can also include respective matching scores of each of the software products represented in the given set of potential products 104, such as in order of statistically computed likelihood of respective corresponding software product. The matching score can be represented as any of a variety of metrics, such as a raw score, an adjusted score, a percentage, and the like. Therefore, a given user of the computer system 12 can be able to identify respective likelihoods that the files 20 in a given list of files 102 are associated with the respective software products that are identified in the respective set of potential products 104. Additionally, if the software comparator 28 is unable to identify any software products with which the files 20 are likely to be associated, or if none of the matching scores generated by the matching algorithm 30 exceed a given threshold, then the respective set of potential products 104 can specify “no match”, such as to indicate that the files 20 cannot be identified as belonging to any software products in the software product reference storage 26.

It is to be understood that the software-identification report 100 is not limited to the example of FIG. 3. For example, the software-identification report 100 can include any of a variety of additional information, such as timestamps, associated file systems 18 of the files 20, information associated with the file signatures 50 of the files 20 in the lists of files 102, or any of a variety of other information that may be necessary for troubleshooting or maintaining the computer system 12. In addition, while the lists of files 102 and the sets of potential software products 104 are demonstrated as including multiple items, it is to be understood that a given list of files 102 can include a single file 20, and that a given set of potential products 104 can include a single software product. Therefore, the software-identification report 100 can be organized and configured in any of a variety of ways.

FIG. 4 illustrates an example of a system 150 that can be implemented in accordance with an aspect of the invention. The system 150 is demonstrated in the example of FIG. 4 includes a network 152, such as can include one or more of a LAN and/or WAN (e.g., the Internet). Thus, the system 150 can be configured as an Internet-based system. The system 150 includes a Global Trust Repository (GTR) 154 that can be configured substantially similar to the trust repository 16 in the example of FIG. 1. The GTR 154 is connected to a network 152 and is configured to store predetermined file signature data associated with a very large number (e.g., billions) of files that correspond to a very large number (e.g., millions) of software products. As an example, the predetermined file signature data can include predetermined cryptographic hash data associated with the respective files of the software products. The predetermined file signature data can be stored in a software product reference storage, similar to as described previously in the example of FIG. 1. Thus, the GTR 154 can be configured to service worldwide software-identification requests.

The network system 150 also includes one or more enterprise trust servers (ETSs) 156. Each ETS 156 can be implemented as a different computing device, or multiple ETSs 156 can be provided on a signal computing device. In the example of FIG. 4, there is demonstrated a plurality X of ETSs 156, where X is a positive integer, in which each ETS 156 is coupled to the network 152. As an example, each of the ETSs 156 can be associated with a private enterprise network, a local area network (LAN), or a geographical division of the service area of a network service provider. For instance each ETS 156 can be implemented by a different entity, such as can be a person, a business (e.g., corporation, partnership, company or the like), or a group or division of a company. Each of the ETSs 156 is communicatively coupled to one or more computer systems 158, which can include a large number of computer systems 158, via a network. As an example, each of the ETSs 156 can be communicatively coupled with respective computer system(s) 158 via a LAN, WAN, or other network, including the network 152.

Similar to as described previously with respect to the example of FIG. 1, a given ETS 156 can initiate (e.g., automatically or in response to a user input) a software-identification request that is provided to a respective ETS client that can be resident on one or more of the respective computer systems 158 that is serviced by the given ETS 156. The respective ETS client can scan the files delineated in the software-identification request from file systems of the one or more of the computer(s) 158 and can generate file signatures associated with each of the files. The file signatures can include, for example, cryptographic hash data associated with the file content of the respective files. The file signatures are thus transmitted via the network 152 to the respective ETS 156 as a client request, and then to the GTR 154 as a product ID request. Similar to as described previously in the example of FIG. 1, the GTR 154 can include a software comparator that is configured to implement a matching algorithm to compare the file signature data (e.g., the cryptographic hash data) with the predetermined file signature data for identification of software products with which respective files are associated. The GTR 154 can transmit the results of the comparison back to the respective ETS 156, which can generate a software-identification report that can be provided to the respective one or more computer(s) 158 or can be accessible from the respective ETS 156, similar to as described previously in the examples of FIGS. 1 and 3.

The network system 150 further includes software product resources 160. As an example, the software product resources 160 can include a plurality of software products that are located on various websites on the network 152. As an example, the GTR 154 can include automated and manual harvesting methods that monitor the respective vendor websites and software download portals for major commercial software vendors and download new software products when they are released. As another example, the software product resources 160 can also be accessed via portals to specific commercial vendors that provide secure connections to the GTR 154, such as for uploading software products and corresponding software files to the GTR 154, such as in response to requests or financial transactions. The downloaded software products can be deconstructed by a front end system of the GTR 154, or by the GTR 154 itself, and all of the contained files can be scanned to create predetermined file signature data, such as including the predetermined cryptographic hash data of the file content (see, e.g., FIG. 2 and its corresponding description herein). The created predetermined file signatures can be packaged together with information (e.g., metadata) on the specific software product with which they are associated and can be stored as the predetermined file signature data, including the predetermined cryptographic hash data, in an associated database (e.g., a software product reference storage). In addition, the GTR 154 can be configured to, in response to being unable to identify a given software product based on a file signature (e.g., the cryptographic hash data) provided in the file signature data, store the file signature in the associated database, such as for future identification based on subsequent website harvesting or for matching with other similar file signatures for determining file associations.

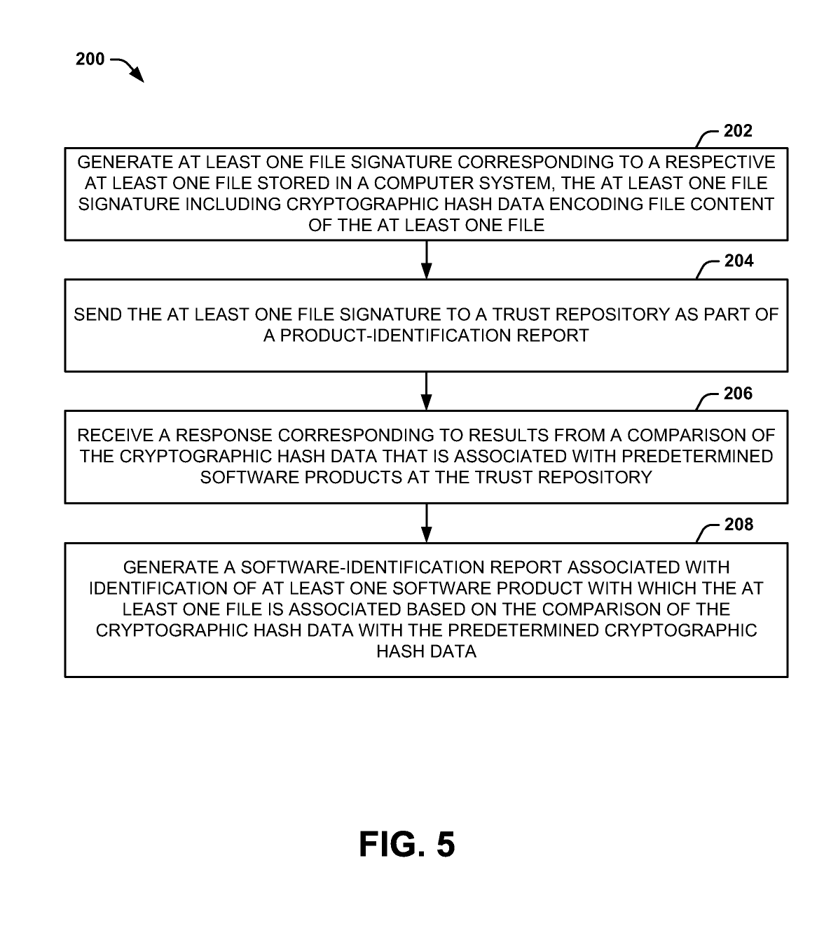

In view of the foregoing structural and functional features described above, an example method will be better appreciated with reference to FIG. 5. While, for purposes of simplicity of explanation, the method of FIG. 5 is shown and described as executing serially, it is to be understood and appreciated that the present invention is not limited by the illustrated order, as some aspects could, in accordance with the present invention, occur in different orders and/or concurrently with other aspects from that shown and described herein. Moreover, not all illustrated features may be required to implement a method. The example methods of FIG. 5 can be implemented as computer-readable instructions that can be stored in a non-transitory computer readable medium, such as can be computer program product or other memory storage. The computer readable instructions corresponding to the method of FIG. 5 can also be accessed from memory and be executed by a processor (e.g., a processing unit of the computer system 12 of FIG. 1).

FIG. 5 illustrates an example of a method 200 for identifying software on a computer system (e.g., the computer system 12 of FIG. 1). At 202, at least one file signature corresponding to the respective at least one file stored in a computer system is generated, the at least one file signature including cryptographic hash data encoding file content of the at least one file. The file signature(s) can be generated by an ETS client based on a software-identification request that includes a list of files on respective one or more file systems or file containers (e.g., file system folders) for which software-identification is requested. The software-identification request can be initiated by a user of the computer system, or a user of an ETS via a user interface at the ETS, or can be initiated automatically and/or periodically by the computer system or the ETS. Each file signature can include cryptographic hash data associated with file content of the at least one file. The file signature can also include other characteristics of the respective file, such as file name, file system path, file attributes, and/or file permissions (see, e.g., FIG. 2). At 204, the at least one file signature is sent to a trust repository as part of a product identification request. The trust repository can be a GTR coupled to the Internet that services worldwide software-identification requests.

At 206, a response corresponding to results from a comparison of the cryptographic hash data with predetermined cryptographic hash data that is associated with predetermined software products at the trust repository is received. The comparison can be performed by a matching algorithm (e.g., matching algorithm 30 of FIG. 1) implemented at the trust repository that stores predetermined file signature data that includes the predetermined cryptographic hash data. At 208, a software-identification report associated with identification of at least one software product with which the at least one file is associated is generated based on the comparison of the cryptographic hash data with the predetermined cryptographic hash data. The software-identification report can include a list of likely software products associated with respective lists of files, such as including a metric that indicates the likelihood.

What have been described above are examples. It is, of course, not possible to describe every conceivable combination of components or methods, but one of ordinary skill in the art will recognize that many further combinations and permutations are possible. Accordingly, the invention is intended to embrace all such alterations, modifications, and variations that fall within the scope of this application, including the appended claims. Additionally, where the disclosure or claims recite “a,” “an,” “a first,” or “another” element, or the equivalent thereof, it should be interpreted to include one or more than one such element, neither requiring nor excluding two or more such elements. As used herein, the term “includes” means includes but not limited to, and the term “including” means including but not limited to. The term “based on” means based at least in part on.

What is claimed is:

1. A software identification system comprising:
an enterprise trust server configured to initiate a scan of at least one file of a file system of a computer system to generate a respective at least one file signature, the at least one file signature comprising cryptographic hash data associated with file content of the at least one file; and
a trust repository configured to receive the at least one file signature and to compare the at least one file signature, including the cryptographic hash data associated with the file content thereof, with predetermined file signature data that is stored in a software product reference storage, the predetermined file signature data including cryptographic hash values associated with respective files in predetermined corresponding software products to enable identification of at least one software product with which the at least one file is associated.

2. The system of claim 1, wherein the trust repository is further configured to provide comparison data to the enterprise trust server based on a result of the comparison, and wherein the enterprise trust server is further configured to generate a user-viewable software-identification report based on the comparison data.

3. The system of claim 2, wherein the software-identification report comprises a list of potential software products with which the at least one file is associated.

4. The system of claim 1, wherein the trust repository comprises a matching algorithm programmed to evaluate the cryptographic hash data with respect to the cryptographic hash values associated with the respective files in the predetermined file signature data to generate a matching score corresponding to a likelihood that a respective software product of the list of potential software products corresponds to the at least one software product with which the at least one file is associated, the enterprise trust server providing a report that includes matching scores associated with a plurality of software products.

5. The system of claim 1, wherein, in response to a request from the enterprise trust server, an enterprise trust server client is configured to access the at least one file from the at least one file system of the computer system and to generate the respective at least one file signature.

6. The system of claim 5, wherein the request comprises a request for identification of the at least one software product with which the at least one file is associated, wherein each of the at least one file signature includes corresponding cryptographic hash data, the enterprise trust server sending the at least one file signature for each of the respective at least one file to the trust repository to request identification of the at least one software product with which the at least one file is associated.

7. The system of claim 6, wherein the enterprise trust server is further configured to generate a software-identification report corresponding to the at least one software product with which each of the at least one file is associated based on results of the comparison by the trust repository.

8. The system of claim 1, wherein the cryptographic hash data is generated based on a non-reversible data encoding algorithm that substantially uniquely identifies the at least one file.

9. A network system comprising the software identification system of claim 1, wherein the enterprise trust server is one of a plurality of enterprise trust servers, wherein the trust repository is configured as a global trust repository in communication with the plurality of enterprise trust servers via a network, wherein the global trust repository is configured to save the at least one file signature as a portion of predetermined software file signature data comprising the cryptographic hash values associated with the respective files in the predetermined file signature data in the software product reference storage in response to the predetermined file signature data not comprising a substantially exact match of the at least one file signature.

10. The network system of claim 9, wherein the global trust repository is configured to periodically access software resources from a plurality of websites via the network to generate the predetermined software file signature data.

11. A non-transitory computer-readable medium programmed for performing a method for identifying software on a computer system, the method comprising:
generating at least one file signature corresponding to a respective at least one file stored in a computer system, the at least one file signature including cryptographic hash data encoding file content of the at least one file;
sending the at least one file signature to a trust repository as part of a product-identification request;
receiving a response corresponding to results from a comparison of the cryptographic hash data with predetermined cryptographic hash data that is associated with predetermined software products at the trust repository; and
generating a software-identification report associated with identification of at least one software product with which the at least one file is associated based on the comparison of the cryptographic hash data with the predetermined cryptographic hash data.

12. The medium of claim 11, wherein the results are derived according to a matching algorithm that compares the at least one file signature with respect to the predetermined software file signature data, the response including a matching score corresponding to a likelihood that a respective software product of the at least one software product corresponds to the at least one software product with which the at least one file is associated, and wherein generating the software-identification report comprises providing the matching score corresponding to each software product in the at least one software product.

13. The medium of claim 11, wherein the method further comprises initiating a software-identification request comprising a plurality of files for which identification of the at least one software product is requested, wherein generating the software-identification report comprises generating the software-identification report associated with identification of at least one software product associated with a plurality of files identified in the software-identification request, wherein each of a plurality of file signatures associated with the respective plurality of files includes cryptographic hash data that is generated for each of the plurality of files.

14. The medium of claim 13, wherein identifying the plurality of files comprises identifying the plurality of files in a plurality of file systems associated with the computer system, the response including an identification of each of the plurality of files identified in the software-identification request and an indication of a likelihood that each respective file is associated with the at least one software product.

15. The medium of claim 13, wherein providing the software-identification report comprises providing a separate software-identification report to each of a plurality of computer systems in response to a respective request from each of the plurality of computer systems.

16. The medium of claim 11, wherein generating the at least one file signature comprises generating the cryptographic hash data based on a non-reversible data encoding algorithm that substantially uniquely identifies the associated at least one file.

17. A network system comprising:
a plurality of enterprise trust servers that are each configured to initiate a scan of a plurality of files from at least one file system associated with at least one computer system and to generate a plurality of file signatures corresponding to the respective plurality of files, each of the plurality of file signatures comprising cryptographic hash data associated with file content of the respective one of the plurality of files; and
a trust repository communicatively coupled to the plurality of enterprise trust servers via a network and configured to receive a product identification request that includes the plurality of file signatures from each of the plurality of enterprise trust servers, the trust repository being further configured to compare the plurality of file signatures including the cryptographic hash data associated with the file content thereof with predetermined file signatures stored in a software product reference storage, the predetermined file signatures stored in the software product reference storage being associated with predetermined known software products to enable identification of at least one software product with which each of the plurality of files is associated.

18. The system of claim 17, wherein the trust repository is further configured to provide data associated with a result of the comparison to the plurality of enterprise trust servers, and wherein the plurality of enterprise trust servers are each further configured to generate a software-identification report associated with the result of the comparison that is provided to each of the at least one computer system, the software-identification report comprising a list of potential software products corresponding to the at least one software product with which each of the plurality of files in the request is associated, the software-identification report comprising a matching score corresponding to each software product in the list of potential software products, the matching score corresponding to a likelihood that a respective software product of the list of potential software products corresponds to the at least one software product with which the plurality of files is associated.

19. The system of claim 17, wherein the trust repository is configured to save at least one of the plurality of file signatures as a portion of the predetermined software file signature data in the software product reference storage in response to the predetermined software file signature data not comprising a substantially exact match of the at least one file signature.

20. The system of claim 17, wherein the trust repository is configured to periodically access software resources from a plurality of websites on the network to generate the predetermined software file signature data.
